(19) United States
(12) Patent Application Publication
(10) Pub. No.: US 2020/0307538 A1
(43) Pub. Date: Oct. 1, 2020

(54) BRAKE SYSTEM WITH MULTIPLE PRESSURE SOURCES

(71) Applicant: ZF ACTIVE SAFEY US INC., Livonia, MI (US)

(72) Inventor: Blaise J. Ganzel, Livonia, MI (US)

(21) Appl. No.: 16/765,590

(22) PCT Filed: Nov. 29, 2018
(86) PCT No.: PCT/US2018/063011

§ 371 Date: May 20, 2020

Related U.S. Application Data
(60) Provisional application No. 62/592,175, filed on Nov. 29, 2017.

(51) Int. Cl. B60T 13/68; B60T 13/16; B60T 13/74; B60T 8/40; B60T 7/04

(52) U.S. Cl. CPC B60T 13/686; B60T 13/168; B60T 13/745; B60T 2270/404; B60T 7/042; B60T 2270/402; B60T 2270/82; B60T 8/4081

(57) ABSTRACT

A brake for operating first, second, third, and fourth wheel brakes includes first and second hydraulic brake circuits each defining a fluid conduit to two of the wheel brakes. Each circuit includes a power transmission unit having a first motor driven piston for pressurizing pressure chambers therein for providing pressurized fluid to the respective fluid conduits. Each circuit includes at least a pair of valves adapted to selectively provide pressurized fluid from the fluid conduits to each one of the wheel brakes. The system includes two separate electronic control units for controlling each of the circuits, namely the power transmission units and the pair of valves.

### CROSS-REFERENCE TO RELATED APPLICATIONS

This application claims the benefit of U.S. Provisional Application No. 62/592,175, filed Nov. 29, 2017, the disclosure of which is incorporated herein by reference.

### BACKGROUND OF THE INVENTION

This invention relates in general to vehicle braking systems. Vehicles are commonly slowed and stopped with hydraulic brake systems. These systems vary in complexity but a base brake system typically includes a brake pedal, a tandem master cylinder, fluid conduits arranged in two similar but separate brake circuits, and wheel brakes in each circuit. The driver of the vehicle operates a brake pedal which is connected to the master cylinder. When the brake pedal is depressed, the master cylinder generates hydraulic forces in both brake circuits by pressurizing brake fluid. The pressurized fluid travels through the fluid conduit in both circuits to actuate brake cylinders at the wheels to slow the vehicle.

Some base brake systems may use a brake booster which provides a force to the master cylinder which assists the pedal force created by the driver. The booster can be vacuum or hydraulically operated. A typical hydraulic booster senses the movement of the brake pedal and generates pressurized fluid which is introduced into the master cylinder. The fluid from the booster assists the pedal force acting on the pistons of the master cylinder which generate pressurized fluid in the conduit in fluid communication with the wheel brakes. Thus, the pressures generated by the master cylinder are increased. Hydraulic boosters are commonly located adjacent the master cylinder piston and use a boost valve to control the pressurized fluid applied to the booster.

Braking a vehicle in a controlled manner under adverse conditions requires precise application of the brakes by the driver. Under these conditions, a driver can easily apply excessive braking pressure thus causing one or more wheels to lock, resulting in excessive slippage between the wheel and road surface. Such wheel lock-up conditions can lead to greater stopping distances and possible loss of directional control.

Advances in braking technology have led to the introduction of Anti-lock Braking Systems (ABS). An ABS system monitors wheel rotational behavior and selectively applies and relieves brake pressure in the corresponding wheel brakes in order to maintain the wheel speed within a selected slip range to achieve maximum braking force. While such systems are typically adapted to control the braking of each braked wheel of the vehicle, some systems have been developed for controlling the braking of only a portion of the plurality of braked wheels. Electronically controlled ABS valves, comprising apply valves and dump valves, are located between the master cylinder and the wheel brakes. The ABS valves regulate the pressure between the master cylinder and the wheel brakes. Typically, when activated, these ABS valves operate in three pressure control modes: pressure apply, pressure dump and pressure hold. The apply valves allow pressurized brake fluid into respective ones of the wheel brakes to increase pressure during the apply mode, and the dump valves relieve brake fluid from their associated wheel brakes during the dump mode. Wheel brake pressure is held constant during the hold mode by closing both the apply valves and the dump valves.

To achieve maximum braking forces while maintaining vehicle stability, it is desirable to achieve optimum slip levels at the wheels of both the front and rear axles. During vehicle deceleration different braking forces are required at the front and rear axles to reach the desired slip levels. Therefore, the brake pressures should be proportioned between the front and rear brakes to achieve the highest braking forces at each axle. ABS systems with such ability, known as Dynamic Rear Proportioning (DRP) systems, use the ABS valves to separately control the braking pressures on the front and rear wheels to dynamically achieve optimum braking performance at the front and rear axles under the then current conditions.

A further development in braking technology has led to the introduction of Traction Control (TC) systems. Typically, valves have been added to existing ABS systems to provide a brake system which controls wheel speed during acceleration. Excessive wheel speed during vehicle acceleration leads to wheel slippage and a loss of traction. An electronic control system senses this condition and automatically applies braking pressure to the wheel cylinders of the slipping wheel to reduce the slippage and increase the traction available. In order to achieve optimal vehicle acceleration, pressurized brake fluid is made available to the wheel cylinders even if the master cylinder is not actuated by the driver.

During vehicle motion such as cornering, dynamic forces are generated which can reduce vehicle stability. A Vehicle Stability Control (VSC) brake system improves the stability of the vehicle by counteracting these forces through selective brake actuation. These forces and other vehicle parameters are detected by sensors which signal an electronic control unit. The electronic control unit automatically operates pressure control devices to regulate the amount of hydraulic pressure applied to specific individual wheel brakes. In order to achieve optimal vehicle stability, braking pressures greater than the master cylinder pressure must quickly be available at all times.

Brake systems may also be used for regenerative braking to recapture energy. An electromagnetic force of an electric motor/generator is used in regenerative braking for providing a portion of the braking torque to the vehicle to meet the braking needs of the vehicle. A control module in the brake system communicates with a powertrain control module to provide coordinated braking during regenerative braking as well as braking for wheel lock and skid conditions. For example, as the operator of the vehicle begins to brake during regenerative braking, electromagnet energy of the motor/generator will be used to apply braking torque (i.e., electromagnetic resistance for providing torque to the powertrain) to the vehicle. If it is determined that there is no longer a sufficient amount of storage means to store energy recovered from the regenerative braking or if the regenerative braking cannot meet the demands of the operator, hydraulic braking will be activated to complete all or part of the braking action demanded by the operator. Preferably, the hydraulic braking operates in a regenerative brake blending manner so that the blending is effectively and unnoticeably picked up where the electromagnetic braking left off. It is desired that the vehicle movement should have a smooth transitional change to the hydraulic braking such that the changeover goes unnoticed by the driver of the vehicle.

Brake systems may also include autonomous braking capabilities such as adaptive cruise control (ACC). During an autonomous braking event, various sensors and systems monitor the traffic conditions ahead of the vehicle and automatically activate the brake system to decelerate the vehicle as needed. Autonomous braking may be configured to respond rapidly in order to avoid an emergency situation. The brake system may be activated without the driver depressing the brake pedal or even if the driver fails to apply adequate pressure to the brake pedal. Advanced autonomous braking systems are configured to operate the vehicle without any driver input and rely solely on the various sensors and systems that monitor the traffic conditions surrounding the vehicle.

Some braking systems are configured such that the pressures at each of the wheel brakes can be controlled independently (referred to as a multiplexing operation) from one another even though the brake system may include a single source of pressure. Thus, valves downstream of the pressure source are controlled between their open and closed positions to provide different braking pressures within the wheel brakes. Such multiplex systems, which are all incorporated by reference herein, are disclosed in U.S. Pat. Nos. 8,038,229, 8,371,661, 9,211,874, and U.S. Patent Application Publication No. 2012/0306261.

### SUMMARY OF THE INVENTION

This invention relates to a brake system for operating first, second, third, and fourth wheel brakes. The brake system includes a fluid reservoir. A first hydraulic brake circuit defines a first fluid conduit connected to the first and second wheel brakes. The first hydraulic brake circuit includes a first power transmission unit having a first motor driven piston for pressurizing a first pressure chamber for providing pressurized fluid to the first fluid conduit. A first valve is adapted to selectively provide pressurized fluid from the first fluid conduit to the first wheel brake. A second valve is adapted to selectively provide pressurized fluid from the first fluid conduit to the second wheel brake. A first electronic control unit controls the first power transmission unit and the first and second valves. The brake system further includes a second hydraulic brake circuit defining a second fluid conduit connected to the third and fourth wheel brakes. The second hydraulic brake circuit includes a second power transmission unit including a second motor driven piston for pressurizing a second pressure chamber for providing pressurized fluid to the second fluid conduit. A third valve is adapted to selectively provide pressurized fluid from the second fluid conduit to the third wheel brake. A fourth valve is adapted to selectively provide pressurized fluid from the second fluid conduit to the fourth wheel brake. A second electronic control unit is separate from the first electronic control unit. The second electronic control unit controls the second power transmission unit and the third and fourth valves.

In another aspect of the invention, a brake system includes a pedal simulator and a first hydraulic brake circuit defining a first fluid conduit connected to first and second wheel brakes. The first hydraulic brake circuit includes a first power transmission unit having a first motor driven piston adapted to provide pressurized fluid to the first fluid conduit. A first valve is disposed between the first fluid conduit and the first wheel brake, wherein the first valve is adapted to selectively provide pressurized fluid from the first power transmission unit and the first wheel brake. A second valve is disposed between the first fluid conduit and the second wheel brake, wherein the second valve is adapted to selectively provide pressurized fluid from the first power transmission unit and the second wheel brake. A first electronic control unit controls the first pressure control unit, wherein the first electronic control unit provides multiplex control to the first and second valves to control the pressures at each of the first and second wheel brakes independently from one another. The brake system further includes a second hydraulic brake circuit separate from the first hydraulic brake circuit. The second hydraulic brake circuit defines a second fluid conduit connected to third and fourth wheel brakes. The second hydraulic brake circuit includes a second power transmission unit having a motor driven piston adapted to provide pressurized fluid to the second fluid conduit. A third valve is disposed between the second fluid conduit and the third wheel brake, wherein the second valve is adapted to selectively provide pressurized fluid from the second power transmission unit and the third wheel brake. A fourth valve is disposed between the second fluid conduit and the fourth wheel brake, wherein the fourth valve is adapted to selectively provide pressurized fluid from the second power transmission unit and the fourth wheel brake. A second electronic control unit controls the second pressure control unit, wherein the second electronic control unit provides multiplex control to the third and fourth valves to control the pressures at each of the third and fourth wheel brakes independently from one another.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a schematic illustration of a first embodiment of a brake system.

FIG. 2 is an enlarged schematic illustration of a power transmission unit of the brake system of FIG. 1.

FIG. 3 is an enlarged schematic illustration of the pedal simulator of the brake system of FIG. 1.

FIG. 4 is a schematic illustration of a second embodiment of a brake system.

FIG. 5 is a schematic illustration of a third embodiment of a brake system.

### DETAILED DESCRIPTION OF THE PREFERRED EMBODIMENT

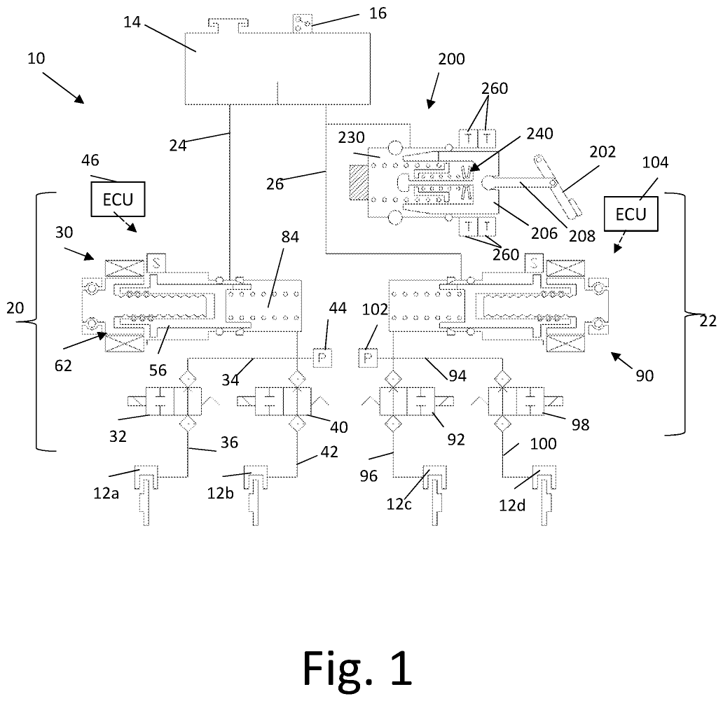

Referring now to the drawings, there is schematically illustrated in FIG. 1 an embodiment of a vehicle brake system, indicated generally at 10. The brake system 10 may suitably be used on a vehicle, such as an automobile, having four wheels with hydraulically actuated wheel brake associated with each wheel. Wheel brakes 12a, 12b, 12c, and 12d can be any suitable wheel brake structure operated by the application of pressurized brake fluid. The wheel brake 12a, 12b, 12c, and 12d may include, for example, a brake caliper mounted on the vehicle to engage a frictional element (such as a brake disc) that rotates with a vehicle wheel to effect braking of the associated vehicle wheel. The wheel brakes 12a, 12b, 12c, and 12d can be associated with any combination of front and rear wheels of the vehicle in which the brake system 10 is installed. For example, in a diagonally split brake system, the wheel brakes 12a and 12d may be associated with one side of the vehicle, and the wheel brakes 12b and 12c may be associated with the other side of the vehicle. Alternatively, wheel brakes 12a and 12b may be associated with the front wheels and wheel brakes 12c and 12d may be associated with rear wheels.

The brake system 10 can be provided with braking functions such as anti-lock braking (ABS) and other slip control features to effectively brake the vehicle. Additionally, the brake system 10 may be ideally suited with vehicles equipped with autonomous driving features.

The brake system 10 includes a fluid reservoir 14 for storing and holding hydraulic fluid for the brake system 10. The fluid within the reservoir 14 is preferably held generally at or near atmospheric pressure. Of course, the reservoir 14 may be designed to store the fluid therein at other pressures if so desired. The brake system 10 may include a fluid level sensor 16 for detecting the fluid level of the reservoir 14. The fluid level sensor 16 may be helpful in determining whether a leak has occurred in the system 10.

In a preferred embodiment of the invention, the brake system 10 includes first and second hydraulic circuits, indicated generally at 20 and 22, respectively. Each of the first and second hydraulic circuits 20 and 22 includes various components and fluid conduits which will be explained in detail below. In one embodiment of the invention, the configuration of the first and second circuits 20 and 22 are similar in structure and function. The first hydraulic circuit 20 is in fluid communication with the reservoir 14 via a fluid conduit 24. Similarly, the second hydraulic circuit 22 is in fluid communication with the reservoir 14 via a fluid conduit 26. For reasons which will be explained in further detail below, the first and second hydraulic circuits 20 and 22 are not connected with one another other than their fluid connection to the reservoir 14 via the conduits 24 and 26, respectively. In other words, any pressure build up from one of the first and second hydraulic circuits 20 and 22 will not affect the other of the first and second hydraulic circuits 22 and 20. One advantage of this configuration is that nearly any failure of one of the first and second hydraulic circuits 20 and 22 is not likely to affect the other of the first and second hydraulic circuits 22 and 20.

The first hydraulic circuit 20 includes a power transmission unit, indicated generally at 30. As will be explained in detail below, the power transmission unit 30 provides a source of pressurized fluid for the first hydraulic circuit 20 to selectively actuate the wheel brakes 12a and 12b. The first hydraulic brake circuit 20 further includes a first valve 32 that is in fluid communication with the power transmission unit 30 via a conduit 34. The first valve 32 is in fluid communication with the wheel brake 12a via a conduit 36. The first hydraulic brake circuit 20 also includes a second valve 40 that is in fluid communication with the power transmission unit 30 via the conduit 34. The second valve 40 is in fluid communication with the wheel brake 12b via a conduit 42. The first and second valves 32 and 40 may be configured as solenoid actuated digital type on/off valves such that fluid communication is permitted or restricted therethrough. Alternatively, the first and second valves 32 and 40 may be configured to be operated in an electronically proportionally controlled manner and not merely a digital type on/off valve. Thus, the pressure and/or flow rate through the valves 32 and 40 may be controlled between their extreme open and closed positions.

The first hydraulic circuit 20 may further include a pressure sensor or pressure transducer 44 for detecting the pressure within the fluid conduit 34. The pressure transducer 44 is in communication with an electronic control unit or ECU 46. The ECU 46 may include a microprocessor for receiving signals from various vehicle sensors, as well as sensors from the brake system 10, to control the power transmission unit 30 to regulate the amount of hydraulic pressure within the fluid conduit 34 for applying a desired braking force to the wheel brakes 12a and 12b. The ECU 46 receives various signals, processes signals, and controls the operation of various electrical components of the brake system 10 in response to the received signals. The ECU 46 can be connected to various sensors such as pressure sensors, travel sensors, switches, wheel speed sensors, and steering angle sensors. The ECU 46 may also be connected to an external module (not shown) for receiving information related to yaw rate, lateral acceleration, longitudinal acceleration of the vehicle such as for controlling the brake system 10 during vehicle stability operation. Additionally, the ECU 46 may be connected to an instrument cluster for collecting and supplying information related to warning indicators such as ABS warning light, brake fluid level warning light, and traction control/vehicle stability control indicator light.

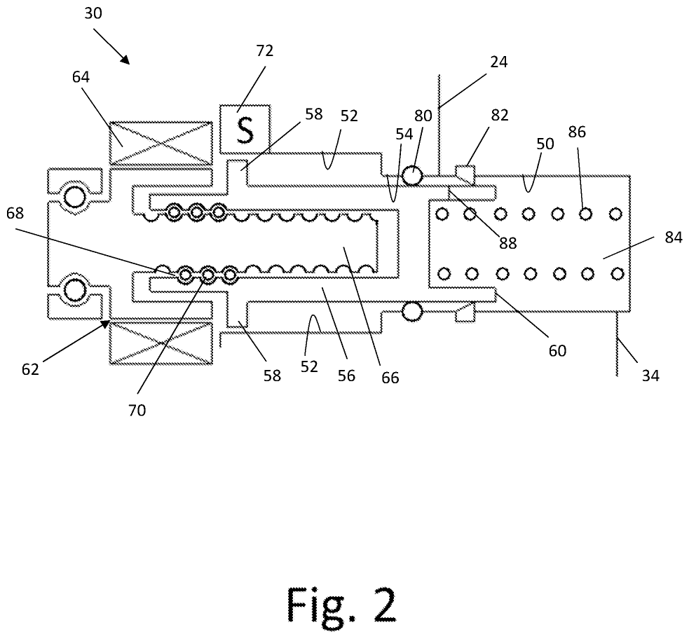

Referring to the enlarged schematic illustration of FIG. 2, the power transmission unit 30 includes a housing defining a bore 50 formed therein. The bore 50 includes a pair of outwardly extending slots 52 formed in a cylindrical wall 54 of the housing. A piston 56 is slidably disposed in the bore 50. The piston 56 includes a pair of anti-rotation pins 58 extending outwardly therefrom. Each pin 58 extends into a respective slot 52 and slide along the length of the slots 52 when the piston 56 travels within the bore 50. The bore 50 also includes a distal end portion 60 slidably disposed in the bore 50. The other end of the piston 56 is connected to a ball screw mechanism, indicated generally at 62. The ball screw mechanism 62 is controlled by the ECU 46. The ball screw mechanism 62 is provided to impart translational or linear motion of the piston 56 along an axis defined by the bore 50 in both a forward direction (rightward as viewing FIGS. 1 and 2), and a rearward direction (leftward as viewing FIGS. 1 and 2) within the bore 50. In the embodiment shown, the ball screw mechanism 62 includes a motor 64 rotatably driving a screw shaft 66. The piston 56 includes a threaded bore 68 and functions as a driven nut of the ball screw mechanism 62. The ball screw mechanism 62 includes a plurality of balls 70 that are retained within helical raceways formed in the screw shaft 66 and the threaded bore 68 of the piston 56 to reduce friction. Although a ball screw mechanism 62 is shown and described with respect to the power transmission unit 30, it should be understood that other suitable mechanical linear actuators may be used for imparting movement of the piston 56. It should also be understood that although the piston 56 functions as the nut of the ball screw mechanism 62, the piston 56 could be configured to function as a screw shaft of the ball screw mechanism 62. Of course, under this circumstance, the screw shaft 66 would be configured to function as a nut having internal helical raceways formed therein.

The power transmission unit 30 preferably includes a sensor 72 for detecting the position of the piston 56 within the bore 50. The sensor 72 is in communication with the ECU 46. In one embodiment, the sensor 72 may detect the position of the piston 56, or alternatively, metallic or magnetic elements embedded with the piston 56. In an alternate embodiment, the sensor 72 may detect the rotational position of the motor 64 and/or ball screw mechanism 62 which is indicative of the position of the piston 56.

The power transmission unit 30 includes first and second seals 80 and 82 which are slidably engaged with the end portion 60 of the piston 56. The end portion 60 of the piston 56, the second seal 82, and the bore 50 define a pressure chamber 84 of the power transmission unit 30. The pressure chamber 84 is in fluid communication with the fluid conduit 34. As will be described below, rightward movement of the piston 56 reduces the volume of the pressure chamber 84 which may increase the pressure therein depending on the operating positions of the first and second valves 32 and 40 and the wheel brakes 12a and 12b. A return spring 86 may be utilized to bias the piston 56 in a leftward direction, as viewing FIGS. 1 and 2, such as returning the piston 56 to its initial position as shown in FIGS. 1 and 2.

As shown in FIG. 2, the conduit 24 from the reservoir 14 enters the bore 50 between the first and second seals 80 and 82. When the piston 56 is in its initial position, as shown in FIGS. 1 and 2, the pressure chamber 84 is in fluid communication with the reservoir 14 via a passageway 88 formed in the end portion 60 of the piston 56. As will be discussed in detail below, sufficient rightward movement of the piston 56 will cause the passageway 88 to be moved beyond the second seal 82, thereby closing off communication between the pressure chamber 84 and the reservoir 14. The seals 80 and 82 may have any suitable seal structure, such as a lip seal, an O-ring, or a quad ring configuration. For example, the second seal 82 may be formed as a lip seal such that fluid may flow in the direction from the conduit 24 to the pressure chamber 84 if the pressure within the conduit 24 is greater than the pressure within the pressure chamber 84.

Referring to FIG. 1, the second hydraulic circuit 22 is very similar to the first hydraulic circuit 20 in both function and structure. Thus, identical components may be manufactured for use in both hydraulic circuits 20 and 22, thereby helping to reduce the overall cost of the brake circuit 10. It is noted that descriptions of the components of the first hydraulic circuit 20 described above, will also relate to the components of the second hydraulic circuit 22.

The second hydraulic circuit 20 includes a power transmission unit, indicated generally at 90. The second hydraulic brake circuit 22 further includes a third valve 92 that is in fluid communication with the power transmission unit 90 via a conduit 94. The third valve 92 is in fluid communication with the wheel brake 12c via a conduit 96. The second hydraulic brake circuit 22 also includes a fourth valve 98 that is in fluid communication with the power transmission unit 90 via the conduit 94. The fourth valve 98 is in fluid communication with the wheel brake 12d via a conduit 100.

The second hydraulic circuit 22 may further include a pressure transducer 102 for detecting the pressure within the fluid conduit 94. The pressure transducer 102 is in communication with an electronic control unit or ECU 104. Similar to the ECU 46, the ECU 104 may include a microprocessor for receiving signals from various vehicle sensors, as well as sensors from the brake system 10, to control the power transmission unit 90 to regulate the amount of hydraulic pressure within the fluid conduit 94 for applying a desired braking force to the wheel brakes 12c and 12d. Although the ECUs 46 and 104 may be configured into a single component or block, in one embodiment of the invention, the ECUs 46 and 104 are separate and distinct components for providing redundancy to the brake system 10. For example, if one of the ECUs 46 and 104 fails either by power interruption or component failure such that control of the corresponding hydraulic brake circuit 20 or 22 is problematic, the other of the hydraulic brake circuit 22 or 20 can be appropriately controlled to decelerate the vehicle.

The power transmission unit 90 is similar in function and structure as the power transmission unit 30 described above with respect to FIG. 2. Thus, the detailed description of the power transmission unit 90 will not be further described herein. It should be understood that details of the description and operation of the power transmission unit 90 may be similar to the description and operation of the power transmission unit 30 discussed herein.

Referring to FIG. 1, the brake system 10 further includes a pedal simulator, indicated generally at 200. The pedal simulator 200 is connected to a brake pedal 202 which is operated by the driver of the vehicle in which the brake system 10 is installed. One of the purposes of the pedal simulator 200 is to provide a force feedback to the driver as the driver depresses the brake pedal 202. In general, the larger the force that the driver applies to the brake pedal 202, the greater the brake system 10 will generate braking forces at the wheel brakes 12a, 12b, 12c, and 12d. Of course, the brake system 10 may not operate under this manner, such as for example, under anti-lock braking or vehicle stability conditions in which the brake system 10 may actuate the wheel brakes 12a, 12b, 12c, and 12d contrary to the driver's intention via the force applied to the brake pedal 202. This force feedback from the pedal simulator 200 may be configured to mimic the forces the driver “feels” against their foot while depressing the brake pedal of a conventional brake system utilizing a master cylinder and hydraulically actuated wheel brakes. Unlike other conventional brake systems, the brake system 10 does not utilize the actuation of the brake pedal 202 to provide pressurized fluid to the brake system 10 either in normal operation or under failed conditions. Thus, the brake system 10 does not utilize a manual push through operation in which pressurized fluid caused by depression of the brake pedal 202 is routed to the wheel brakes 12a, 12b, 12c, and 12d.

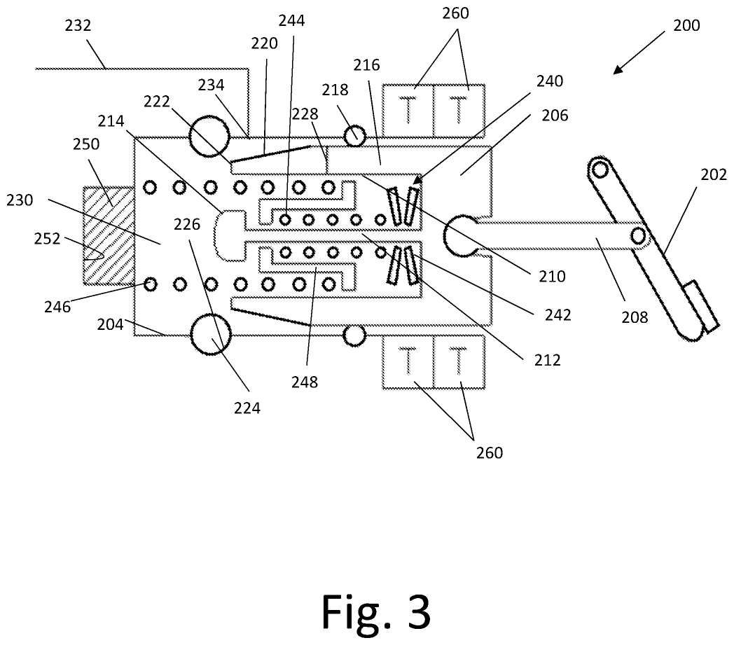

Referring now to the schematic illustration of FIG. 3, the pedal simulator 200 has a housing defining a bore 204. Note that the housing is not specifically schematically shown in FIG. 1 but instead the walls of the bore 204 are illustrated. A piston 206 is slidably disposed in the bore 204. The piston 206 is connected to the brake pedal 202 via a linkage arm 208. The piston 206 has a generally cup shaped configuration defining an inner bore 210. Extending from the inner bore 210 is a stem 212 extending along the axis of the piston 206. The stem 212 includes a rounded end portion 214. The piston 206 includes an outer cylindrical surface 216 which is sealingly engaged with a seal 218. The piston 206 also includes an annular or outer frustoconical surface 220 which tapers in the direction to an end 222 of the piston 206. The frustoconical surface 220 may have any suitable annular shape. As will be explained in detail below, the frustoconical surface 220 engages with an elastomeric member 224 when the piston 206 is moved a sufficient distance in the leftward direction, as viewing FIG. 3. In a preferred embodiment, the elastomeric member 224 is in the form of an O-ring housed in a groove 226 formed in wall of the bore 204.

The bore 204, the piston 206, and seal 218 define a fluid chamber 230. The fluid chamber 230 is in fluid communication with the reservoir 14 via a conduit 232. The conduit 232 preferably includes a damping orifice 234. In a preferred embodiment of the invention, during most operations of the brake system 10, the fluid chamber 230 is at or near atmospheric pressure in conjunction with the fluid pressure within the reservoir 14. However, as will be explained below, during a spike apply in which the driver presses on the brake pedal 202 in a rapid and forceful manner, the damping orifice 234 restricts the flow of fluid through the conduit 232 from the fluid chamber 230, thereby impeding advancement of the piston 206. The size of the damping orifice 234 can be sized accordingly. The piston 206 includes a passageway 228 formed therein to prevent pressure build up within the fluid chamber 230 when the elastomeric member 224 engages with the frustoconical surface 220.

The pedal simulator 200 further includes a spring assembly, indicated generally at 240. The spring assembly 240 is generally housed within the inner bore 210 of the piston 206 as well as the bore 204 of the housing of the pedal simulator 200. The spring assembly 240 may include a number of spring elements to provide the force feedback to the driver as the driver depresses the brake pedal 202. In a preferred embodiment of the invention, the force is not linear but rather has a progressive spring rate, as be described in detail below. A multi-rate or progressive rate characteristic of the spring assembly 240 may be utilized to obtain a desirable force feedback to the driver.

In the illustrated embodiment shown in FIG. 3, the spring assembly 240 generally includes a conical spring washer assembly 242, a first spring 244, a second spring 246, a cup shaped retainer 248, and an elastomeric spring element 250. It should be understood that the configuration of the spring assembly 240 illustrated in FIG. 3 is just one example of a suitable arrangement and that other spring arrangements and spring elements may be used for the spring assembly 240.

The conical spring washer assembly 242 may include one or more conical springs which may have any desirable spring rate. In one embodiment, the conical spring washers of the conical spring washer assembly have a spring rate that is similar to the second spring 246. The first and second springs 244 and 246 may be in the form of cylindrical coil springs. The first spring 244 is housed and retained within the cup shaped retainer 248. The retainer 248 is captured by the end portion 214 of the stem 212 but is permitted to slide in a limited manner relative to the stem 212 during movement of the piston 206. Ends of the first and second springs 244 and 246 act against the retainer 248 such that both of the first and second springs 244 and 246 may be simultaneously compressed during movement of the piston 206. In one embodiment, the first spring 244 has a lower spring rate compared to the second spring 246 such that the first spring 244 will compress more than the second spring 246 during movement of the piston 206. The terms low rate and high rate are used for description purposes and are not intended to be limiting. It should be understood that that the various spring elements of the spring assembly 240 may have any suitable or desirable spring coefficient or spring rate. The elastomeric spring element 250 is mounted within a pocket 252 formed in the housing of the pedal simulator 200.

The pedal simulator 200 preferably further includes a plurality of redundant travel sensors 260. Each of the travel sensors 260 produces a signal that is indicative of the length of travel of the piston 206 and provides the signal to one or both of the ECUs 46 and 104. The travel sensors 260 may detect the rate of travel of the piston 206 as well. In the illustrated embodiment shown, the pedal simulator 200 includes four travel sensors 260. In a preferred embodiment, two travel sensors 260 are used for each of the hydraulic circuits 20 and 22. Thus, two of the travel sensors 260 communicate with the ECU 46, and the other two sensors 260 communicate with the ECU 104. This arrangement provides for redundancy for each of the hydraulic circuits 20 and 22 in case one of the travel sensors 260 fails.

The operation of the brake system 10 will now be described. FIGS. 1 and 3 illustrate the pedal simulator 200 in its rest position (initial position). In this condition, the driver is not depressing the brake pedal 202. Additionally, FIGS. 1 and 2 illustrate the power transmission units 30 and 90 in their rest positions. Also, the valves 32, 40, 92, and 98 are in their open positions, thereby permitting fluid communication with the reservoir 14.

During a typical braking condition, the brake pedal 202 is depressed by the driver of the vehicle causing leftward movement of piston 206 of the pedal simulator 200 by engagement of the linkage arm 208. Movement of the input piston 206 causes the travel sensors 260 to produce signals indicative of the length of travel of the input piston 206 and/or it's rate of travel to the ECUs 46 and 104. Based on these signals indicating the desired braking intent of the driver, the ECUs 46 and 104 will accordingly actuate the power transmission units 30 and 90. Note that under this typical braking condition in which there is no failed conditions of the brake system 10, the hydraulic circuits 20 and 22 function in a similar manner. Thus, only the hydraulic circuit 20 with respect to FIG. 2 will be discussed in detail herein with respect to a normal braking operation.

During this typical braking condition the ECU 46 actuates the motor 64 to rotate the screw shaft 66 in a first rotational direction. Rotation of the screw shaft 66 in the first rotational direction causes the piston 56 to advance in the forward direction (rightward as viewing FIGS. 1 and 2). Note that the capture of the pins 58 within the slots 52 prevent the piston 56 from rotating. Initial sufficient movement of the piston 56 will cause the passageway 88 of the piston 56 to be moved beyond the second seal 82, thereby closing off communication between the pressure chamber 84 and the reservoir 14. Further movement of the piston 56 causes a pressure increase in the pressure chamber 84 and fluid to flow out of the pressure chamber 84 and into the conduit 34. Pressurized fluid from the conduit 34 is directed through the open first and second valves 32 and 40 and directed to the wheel brakes 12a and 12b. The ECU 46 controls the power transmission unit 30 based on the signals from the travel sensors 260 which are indicative of the driver's intent. Thus, the ECU 46 can control the power transmission unit 30 to increase or decrease its output pressure accordingly.

When the driver releases the brake pedal 202, the pressurized fluid from the wheel brakes 12a and 12b may back drive the ball screw mechanism 62 moving the piston 56 back to its rest position. The spring 86 assists in moving the piston 56 back to its rest position. Under certain circumstances, it may also be desirable to actuate the motor 64 of the power transmission unit 30 to retract the piston 56 withdrawing the fluid from the wheel brakes 12a and 12b. Note that the spring 86 may assist in returning the piston 56 to its rest position under certain failed conditions. For example, if the power transmission unit 30 were to fail during a pressure apply, the piston 56 could stop movement within the power transmission unit 30 and remain in a forward position. This may happen, for example, during a power failure of the power transmission unit 30 during actuation thereof. This could cause pressure to be maintained at the wheel brakes 112a and 12b. In this situation, the return spring 86 may assist in returning the piston 56 to its rest position, thereby alleviating any undesirable pressure build up in the wheel brakes 12a and 12b.

During the typical normal braking condition, the driver depresses the brake pedal 202, thereby actuating the pedal simulator 200. As discussed above, the pedal simulator 200 provides a force feedback acting against the driver's foot when pressing against the brake pedal 202. Leftward movement of the piston 206, as viewing FIG. 3, causes compression of the spring assembly 240. More specifically, movement of the piston 206 causes compression of the first and second springs 244 and 246. Depending on the sizes and spring rates of the first and second springs 244 and 246, one of the first and second springs 244 and 246 may bottom out prior to the other of the first and second springs 244 and 246 during sufficient travel of the piston 206. For example, in a preferred embodiment, the second spring 246 has a greater spring rate than the first spring 244 such that the first spring will bottom out before the second spring 246. When bottomed out, the right hand end of the retainer 248 will start compressing the conical spring washer assembly 242. To prevent a sudden or sharp “bend” in force feedback, the compression of the conical spring assembly 242 helps prevents an undesirably rapid change in force experienced by the driver. This arrangement assists in causing a non-linear progressive spring rate characteristic for obtaining a desirable force feedback to the driver. This progressive spring rate may be similar to that shown and described in U.S. Pat. No. 9,371,844, which is hereby incorporated by reference herein. Additionally, sufficient movement of the piston 206 may cause the end portion 214 of the stem 212 to engage with and compress the elastomeric spring element 250, thereby providing a further progressive spring rate characteristic generally at the end of travel of the piston 206. The elastomeric spring element 250 may be configured such that the compression will mimic or simulate the runout of a conventional vacuum booster braking system.

Sufficient movement of the piston 206 during a typical braking condition may also cause engagement of the elastomeric member 224 with the frustoconical surface 220. In addition to the spring assembly 240, engagement of the elastomeric member 224 with the frustoconical surface 220 can assist in providing a desired progressive spring rate characteristic of the pedal simulator 200. During this leftward movement of the piston 206, radially outwardly extending forces are acting on the elastomeric member 224 causing it to be expanded or stretched yet confined in the groove 226. This deformation and expansion results in an increase in frictional forces during movement of the piston 206 caused by the reactionary compressive forces of the elastomeric member 224 acting against the frustoconical surface 220. Due to the frustoconical shape of the surface 220 of the piston 206, the frictional forces increase as the piston 206 moves leftwardly, as viewing FIGS. 1 and 3. Thus, as the piston 206 is advanced, the rate of friction is progressive or increases the farther the piston 206 is advanced in the left-hand direction. The frictional forces from the frustoconical surface 220 also provides a desired force hysteresis. Additionally, as the frustoconical surface 220 is advanced and moves past the port 234, a restriction in flow is occurs to dampen the movement. Higher viscous damping occurs at longer travel. The cross-sectional profile or slope of the frustoconical surface 220 can be configured or shaped to provide a desired progressive hysteresis such that there is increased friction with an increase in travel of the piston 206. For example, the angle or slope of the frustoconical surface 220 may be configured to mimic the “pedal feel” of a conventional vacuum boosted system. It should be understood that the frustoconical surface 220 may have any annular shape and need not be linear or exactly frustoconical in shape. For example, the piston 206 may have two frustoconical surfaces of different slope angles relative to the axis. Thus, the profile of the outer surface of the piston 206 can be formed into any suitable shape to provide a desired feedback force. For example, the frustoconical surface 220 need not be linear (in a cross-sectional profile), as shown in FIG. 3, but can have a curvilinear shape. However, a curvilinear frustoconical shape may be more difficult and expensive to manufacture so a single or multiple linear sloped frustoconical surface may be sufficient to achieve a desired force profile.

In the above description of a typical or normal non-failure braking condition, the first valve 32, the second valve 40, the third valve 92, and the fourth valve 98 are in their open positions, thereby permitting fluid flow to the wheel brakes 12a, 12b, 12c, and 12d, respectively, from the respective power transmission units 30 and 90. The power transmission units 30 and 90 may be actuated to provide an increase or decrease in fluid pressure from their respective pressure chambers 84 to the wheel brakes 12a, 12b, 12c, and 12d. However, the first valve 32, the second valve 40, the third valve 92, and the fourth valve 98 can be actuated individually, in a multiplexing manner, between their open and closed positions to provide different braking pressures within the wheel brakes 12a, 12b, 12c, and 12d for independent control. This may be used during various braking functions such as anti-lock braking, traction control, dynamic rear proportioning, vehicle stability control, hill hold, and regenerative braking. In these situations, the power transmission units 30 and 90 are preferably configured and operated by the ECUs 46 and 104, respectively, such that relatively small rotational increments of the motor 64 and/or ball screw mechanism 62 are obtainable. Thus, small volumes of fluid and relatively minute pressure levels are able to be applied and removed from the conduits 36, 42, 96, and 100 associated with the wheel brakes 12a, 12b, 12c, and 12d. For example, the motor 64 may be actuated to turn 10 of a degree to provide a relatively small amount of fluid and pressure increase. This enables a multiplexing arrangement such that the power transmission units 30 and/or 90 can be controlled to provide individual wheel pressure control. Thus, the power transmission units 30 and 90 and the brake system 10 can be operated to provide individual control for the wheel brakes 12a, 12b, 12c, 12d or can be used to control one or more wheel brakes 12a, 12b, 12c, 12d simultaneously by opening and closing the appropriate valves 32, 40, 92, and 98. The brake system 10 may also be suitable for use in autonomous vehicles or vehicles having an autonomous feature in which braking is desired, yet there is no input from a driver pressing on the brake pedal 202.

Although a single power transmission unit could be utilized to operate the entirety of the brake system 10, it is an advantage of the brake system 10, as illustrated in FIG. 1, to utilize the two power transmission units 30 and 90 for two separate hydraulic circuits 20 and 22. One advantage is that the use of a single power transmission unit for controlling the relatively large simultaneously braking forces for all four wheel brakes 12a, 12b, 12c, and 12d, the single power transmission unit may need to be sized to a relatively large manufactured component. To handle the relatively large pressure forces, the size of the motor and ball screw mechanisms will need to be increased as compared to the smaller power transmission units 30 and 90. A disadvantage of a large motor and ball screw mechanism is the increase in inertia control due to their mass. To sufficiently handle large inertia demands, such as quick changes in rotational directions of the motor, the motor may be need to be designed larger and/or more expensively compared to using smaller motors within the power transmission units 30 and 90. Additionally, multiplex control of two valves for a pair of wheel brakes in a hydraulic circuit 20 or 22 is easier and less demanding than multiplex control for all four wheels since the brake system may need to service or actuate only one wheel brake at a time. In the brake system 10, pressure demands to only two wheel brakes at most are controlled independently during a multiplexing operation.

Another advantage of having two power transmission units 30 and 90 in separate hydraulic circuits 20 and 22 is that if one of the hydraulic circuits 30 or 90 is under a failed condition, the other non-failed hydraulic circuit 90 or 30 can be operated to decelerate the vehicle. Thus, even under a catastrophic failure of one of the hydraulic circuits 30 or 90, the brake system 10 can still be controlled to provide fluid pressure to two wheel brakes 12a, 12b or 12c, 12d. Examples of failures include a detrimental leakage within a hydraulic circuit 30 or 90, loss of electrical power, a failed ECU 46 or 104, or failure of one or more of the components of the hydraulic circuit such as the power transmission unit 30 or 90, one or more of the valves 32, 40, 92, 98, or one or more of the wheel brakes 12a, 12b, 12c, or 12d. Information from the pressure transducers 44 and 102 may be used by the ECUs 46 and 104 for indication of a failure in one of the hydraulic circuits 20 or 22. It is noted that except for a connection to the reservoir 14, the hydraulic circuits 20 and 22 are separate from one another such that the pressurized chambers and conduits are never in fluid communication with one another.

The brake system 10 may also be configured to control three wheel brakes if one of the wheel brakes is inoperable. For example, if a failure occurs in the first wheel brake 12a or a detrimental leak occurs in the conduit 36, the ECU 46 can shuttle the first valve 32 to its closed position, thereby isolating the first wheel brake 12a, and possibly preventing loss of fluid from the hydraulic circuit 310.

Although the ECUs 46 and 104 are preferably separate from one another, the ECUs 46 and 104 may be connected together and are able to communicate with one another. For example, the ECUs 46 and 104 could be connected such that if one ECU (46, for example) fails or any of the components with the hydraulic circuit (20) associated with that ECU (46) fails, the other ECU (104) can identify the failure and then operate its hydraulic circuit (22) accordingly.

Although the brake system 10 was described above utilizing the power transmission units 30 and 90, it should be understood that other controllable sources of pressurized fluid could be used instead in the brake system 10 (or other brake systems described herein). For example, the first and second ECUs 46 and 104 could control motorized pump assemblies (not shown) in place of the power transmission units 30 and 90. Each pump assembly could include an electric motor rotating a shaft having one or more eccentric bearings for driving pumping elements of the pumps. The pump elements provide pressurized fluid to the first and second hydraulic circuits 20 and 22.

It should also be understood that although it is preferred to use a single valve, such as the first valve 32, operated in a multiplex operation to provide the desired pressurized fluid to the first wheel brake 12a, other valve arrangements can be used instead of each single valve actuating each separate wheel brake. For example, each valve 32, 40, 92, and 98 could be replaced with a pair of valves (not shown) that cooperate with one another to provide pressurized fluid to the associated wheel brake and also to vent pressure from the wheel brake. For example, the pair of valves could be solenoid operated valves such that one valve is normally open and in fluid communication with the wheel brake and the conduit 34 or 94, and the other valve is normally closed and in fluid communication with the wheel brake and the reservoir 14.

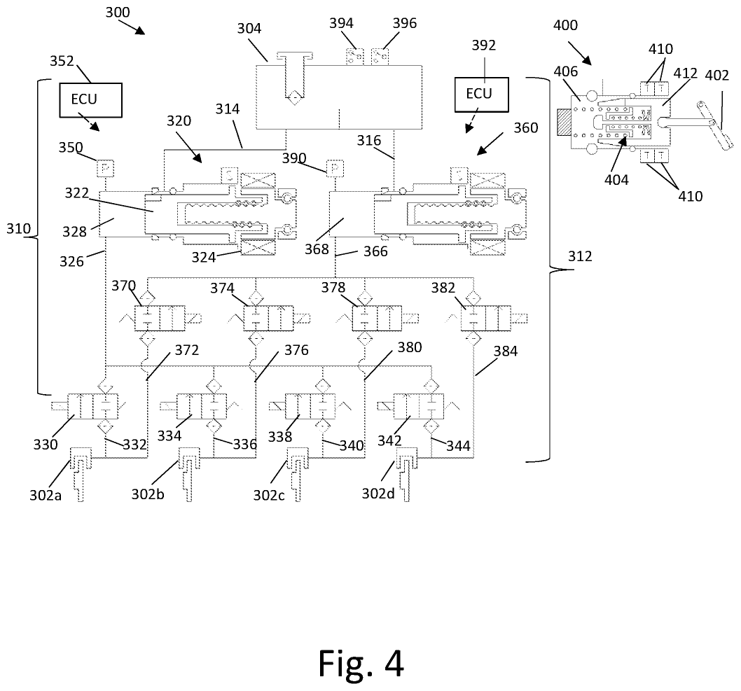

There is schematically illustrated in FIG. 4 a second embodiment of a vehicle brake system, indicated generally at 300. The brake system 300 is similar to the brake system 10 described above. Many of the components of the brake system 300 function in a similar manner and may also be structurally similar as the corresponding components of the brake system 10. Therefore, commonality in the components of the brake system 300 and 10 may not necessarily be described in duplication below.

The brake system 300 includes wheel brakes 302a, 302b, 302c, and 302d. A reservoir 304 stores fluid for the brake system 300. In a preferred embodiment of the invention, the brake system 300 includes first and second hydraulic circuits, indicated generally at 310 and 312, respectively. The first hydraulic circuit 310 is in fluid communication with the reservoir 304 via a fluid conduit 314. Similarly, the second hydraulic circuit 312 is in fluid communication with the reservoir 304 via a fluid conduit 316. Unlike the brake system 10, the first and second hydraulic circuits 310 and 312 are not completely separate from one another. As will be described below, each of the first and second hydraulic circuits 310 and 312 may be connected to any of the wheel brakes 302a, 302b, 302c, and 302d. However, in normal operation under most circumstances in which the brake system 300 is not under a failed condition, the first hydraulic circuit 310 is associated with two of the wheel brakes, and the second hydraulic circuit 312 is associated with the other two wheel brakes.

The first hydraulic circuit 310 includes a power transmission unit, indicated generally 320. Unlike the power transmission units 30 and 90 of the brake system 10, the power transmission unit 320 may provide a source of pressurized fluid to any one of the wheel brakes 302a, 302b, 302c, and/or 302d. However, as will be explained below, in normal braking operations the power transmission unit 320 only supplies pressurized fluid to a pair of wheel brakes. The power transmission unit 320 is similar in structure and function as the power transmission unit 30 described in detail above. One of the differences is that the power transmission unit 320 does not include a return spring similar to the return spring 86 for assisting in returning a piston 322 of the power transmission unit 320 to its rest position. Thus, under certain circumstances, it may also be desirable to actuate a motor 324 of the power transmission unit 320 to retract the piston 322, thereby withdrawing the fluid from the wheel brakes 302a and/or 302b.

The first hydraulic brake circuit 310 further includes four solenoid actuated valves generally associated with the four wheel brakes 302a, 302b, 302c, and 302d. More specifically, a first valve 330 is in fluid communication with a pressure chamber 328 of the power transmission unit 320 via a conduit 326. The first valve 330 is in fluid communication with the wheel brake 302a via a conduit 332. A second valve 334 is in fluid communication with the power transmission unit 320 via the conduit 326. The second valve 334 is in fluid communication with the wheel brake 302b via a conduit 336. A third valve 338 is in fluid communication with the power transmission unit 320 via the conduit 326. The third valve 338 is in fluid communication with the wheel brake 302c via a conduit 340. A fourth valve 342 is in fluid communication with the power transmission unit 320 via the conduit 326. The fourth valve 342 is in fluid communication with the wheel brake 302d via a conduit 344.

The first, second, third, and fourth valves and second valves 330, 334, 338, and 342 may be configured as solenoid actuated digital type on/off valves such that fluid communication is permitted or restricted therethrough. Alternatively, the first, second, third, and fourth valves and second valves 330, 334, 338, and 342 may be configured to be operated in an electronically proportionally controlled manner and not merely a digital type on/off valve. Thus, the pressure and/or flow rate through the first, second, third, and fourth valves and second valves 330, 334, 338, and 342 may be controlled between their extreme open and closed positions.

The first hydraulic circuit 310 may further include a pressure transducer sensor or pressure 350 for detecting the pressure within the fluid conduit 326 and the pressure chamber 328 of the power transmission unit 320. The pressure transducer 350 is in communication with an electronic control unit or ECU 352. Similar to the ECUs 46 and 104, the ECU 352 may include a microprocessor for receiving signals from various vehicle sensors, as well as sensors from the brake system 300, to control the power transmission unit 320 to regulate the amount of hydraulic pressure within the fluid conduit 326 for applying a desired braking force to the wheel brakes 302a, 302b, 302c, and/or 302d.

The second hydraulic circuit 322 is very similar to the first hydraulic circuit 310 in both function and structure. The second hydraulic circuit 322 includes a power transmission unit 360. Like the power transmission unit 320, the power transmission unit 360 may also provide a source of pressurized fluid for selectively actuating any one of the wheel brakes 302a, 302b, 302c and/or 302d.

The second hydraulic brake circuit 312 further includes four solenoid actuated valves generally associated with the four wheel brakes 302a, 302b, 302c, and 302d. More specifically, a fifth valve 370 is in fluid communication with a pressure chamber 368 of the power transmission unit 360 via a conduit 366. The fifth valve 370 is in fluid communication with the wheel brake 302a via a conduit 372. A sixth valve 374 is in fluid communication with the power transmission unit 360 via the conduit 366. The sixth valve 374 is in fluid communication with the wheel brake 302b via a conduit 376. A seventh valve 378 is in fluid communication with the power transmission unit 360 via the conduit 366. The seventh valve 378 is in fluid communication with the wheel brake 302c via a conduit 380. An eighth valve 382 is in fluid communication with the power transmission unit 360 via the conduit 366. The eighth valve 382 is in fluid communication with the wheel brake 302d via a conduit 384.

The fifth, sixth, seventh, and eighth valves 370, 374, 378, and 382 may be configured as solenoid actuated digital type on/off valves such that fluid communication is permitted or restricted therethrough. Alternatively, the fifth, sixth, seventh, and eighth valves 370, 374, 378, and 382 may be configured to be operated in an electronically proportionally controlled manner and not merely a digital type on/off valve. Thus, the pressure and/or flow rate through fifth, sixth, seventh, and eighth valves 370, 374, 378, and 382 may be controlled between their extreme open and closed positions.

The second hydraulic circuit 312 may further include a pressure sensor or pressure transducer 390 for detecting the pressure within the fluid conduit 366 and the pressure chamber 368 of the power transmission unit 360. The pressure transducer 390 is in communication with an electronic control unit or ECU 392. Similar to the ECUs 46, 104, and 352 The ECU 392 may include a microprocessor for receiving signals from various vehicle sensors, as well as sensors from the brake system 300, to control the power transmission unit 360 to regulate the amount of hydraulic pressure within the fluid conduit 366 for applying a desired braking force to the wheel brakes 302a, 302b, 302c, and/or 302d.

The reservoir 304 may include first and second fluid reservoir sensors 394 and 396 to detect the fluid level of the reservoir 304. Although the brake system 10 of FIG. 1 includes a single fluid sensor 16 connected to both of the ECUs 46 and 104, the brake system 300 preferably has a fluid sensor for each ECU. Thus, the first fluid sensor 394 may be connected to the ECU 352, while the second fluid sensor 396 is connected to the ECU 392.

The brake system 300 further includes a pedal simulator, indicated generally at 400. The pedal simulator 400 is similar in structure and function as the pedal simulator 200 of the brake system 10 for providing a force feedback to the driver as the driver depresses a brake pedal 402. However, one of the differences is that the pedal simulator 400 may be “dry” such that there is no fluid communication between the pedal simulator 400 and the reservoir 304. Thus, a spring assembly, indicated generally at 404, of the pedal simulator 400 is housed in a non-fluid filled chamber 406 of the pedal simulator 400, as compared to the “wet” fluid chamber 230 of the pedal simulator 200. Of course, the various spring members of the spring assembly 404 will need to be designed to function properly in the dry environment for years without degradation. Also, it should be understood that any suitable spring structures may be used in the spring assembly 404. It should also be understood that either of the pedal simulators 200 and 400 may be used for either of the brake systems 10 and 300.

Similar to the pedal simulator 200, the pedal simulator 400 preferably further includes a plurality of redundant travel sensors 410. Each of the travel sensors 410 produces a signal that is indicative of the length of travel of a piston 412 of the pedal simulator 400 and provides the signal to one or both of the ECUs 352 and 392. The travel sensors 410 may detect the rate of travel of the piston 412 as well. In the illustrated embodiment shown, the pedal simulator 400 includes four travel sensors 410 such that two of the travel sensors 410 are used for each of the hydraulic circuits 310 and 312. Thus, two of the travel sensors 410 communicate with the ECU 352, and the other two sensors 410 communicate with the ECU 392. This arrangement provides for redundancy for each of the hydraulic circuits 310 and 312 in case one of the travel sensors 402 fails.

The operation of the brake system 300 will now be described. FIG. 4 illustrates the pedal simulator 400 and the power transmission units 320 and 360 in their rest positions (initial positions) such that the driver is not depressing the brake pedal 402. Additionally, FIG. 4 illustrates that all of the first, second, third, fourth, fifth, sixth, seventh, and eighth valves 330, 334, 338, 342, 370, 374, 378, and 382 are in their normally closed positions, such as when the brake system 300 is powered down. Note that this is different than the valves 32, 40, 92, and 98 of the brake system 10 which are normally open solenoid actuated valves.

During a typical normal braking operation, the brake pedal 402 is depressed by the driver of the vehicle causing leftward movement of piston 412 of the pedal simulator 400. The pedal simulator 400 operates in a similar manner as the pedal simulator 200 described above such that movement of the piston 412 generates signals indicative of the length of travel of the piston 412 and/or it's rate of travel to the ECUs 352 and 392. Based on these signals indicating the desired braking intent of the driver, the ECUs 352 and 392 will accordingly actuate the power transmission units 320 and 360. The power transmission units 320 and 360 function in a similar manner as described above with respect to the power transmission unit 30, thereby providing pressurized fluid at desired pressure levels to the conduits 326 and 366.

During this normal braking event, the power transmission unit 320 is preferably associated with actuating a pair of wheel brakes, while the power transmission unit 360 is associated with the other pair of wheel brakes. Thus, while each of the power transmission units 320 and 360 are capable of fluid communication with each of the wheel brakes 302a, 302b, 302c, and 302d, via the first, second, third, fourth, fifth, sixth, seventh, and eighth valves 330, 334, 338, 342, 370, 374, 378, and 382, in a normal braking event, each of the power transmission units 320 and 360 are in fluid communication with only two of the wheel brakes 302a, 302b, 302c, and 302d. For example, either prior to a normal braking event or immediately upon sensing a braking procedure, the third and fourth valves 338 and 342 may be energized to their open positions, thereby permitting fluid flow from the pressure chamber 328 of the power transmission unit 320 to flow into the wheel brakes 302c and 302d, respectively, via the conduits 326, 340, and 344. It is noted that if the third and fourth valves 338 and 342 are controlled to their open positions prior to a normal braking event (and not always left remained energized open), it is preferable that the valve 338 and 342 are periodically opened during non-braking events to assure proper venting. The first and second valves 330 and 334 remain in their closed positions to prevent the power transmission unit 320 from actuating the wheel brakes 302a and 302b. In furtherance of this example, the fifth and sixth valves 370 and 374 are energized to their open positions, thereby permitting fluid flow from the pressure chamber 364 of the power transmission unit 360 to flow into the wheel brakes 302a and 302b, respectively, via the conduits 366, 372, and 376. The seventh and eighth valves 378 and 382 remain in their closed positions to prevent the power transmission unit 360 from actuating the wheel brakes 302c and 302d. In this configuration, the brake system 300 may function in a similar manner as the brake system 10 during a normal brake apply. For advanced braking control, this configuration also enables the brake system 300 to use multiplexing control such that the power transmission units 320 and/or 360 with the necessary valves can be controlled to provide individual wheel pressure control.

In the above example, it is preferred that the third, fourth, fifth, and sixth valves 338, 342, 370, and 372 remain energized throughout the duration of an ignition cycle of the vehicle. Thus, any quick and rapid pressure generated from the power transmission units 320 and 360 can be immediately sent to the respective wheel brakes. Alternatively, to avoid continuous use of electrical power, the brake system 300 could be configured to energize the third, fourth, fifth, and sixth valves 338, 342, 370, and 372 in the above example upon determination of a braking event. In this situation, it is preferred to periodically control the valves in their open positions to assure proper venting.

It is noted that in the above example, only the third, fourth, fifth, and sixth valves 338, 342, 370, and 372 will be actuated during normal braking operations and that the first, second, seventh, and eighth valves 330, 334, 378, and 382, would never be energized. To prevent stagnation and detrimental seal failure due to lack of use and fluid engagement, the brake system 300 is preferably configured to rotate the associations of the power transmission units 320 and 360 to the other non-used valves. Thus, for this example, the brake system 300 could be configured after a predetermined amount of ignition cycles to energize the first and second valves 330 and 334 and keep the third and fourth valves 338 and 342 in their closed positions. Similarly, the seventh and eighth valves 378 and 388 would be energized and the fifth and sixth valves 370 and 374 kept closed.

Although the brake system 300 adds cost and complexity compared to the brake system 10 with the addition of four extra valves, the brake system 300 has the advantage that under certain failed conditions, pressure may be generated from one of the power transmission units 320 or 360 to provide pressure to all four of the wheel brakes 302a, 302b, 302c, and 302d. For example, if a catastrophic failure occurred in the hydraulic circuit 310, the hydraulic circuit 312 could be reconfigured upon detection of this failed condition. In this situation, the first, second, third, and fourth valves 330, 334, 338, and 342 would shuttle (or remain) in their closed positions. The fifth, sixth, seventh, and eighth valves 370, 374, 378, and 388 would be energized to their open positions, thereby permitting fluid communication between the power transmission unit 360 and all four wheel brakes 302a, 302b, 302c, and 302d. Multiplex control of just the single power transmission unit 360 may also be utilized with the necessary valves for advanced brake control, such as wheel slip control.

The brake system 300 may also be configured to control three wheel brakes if one of the wheel brakes is inoperable. For example, if a failure occurs in the first wheel brake 302a or a detrimental leak occurs in the conduit 332, the ECU 352 can shuttle the first valve 330 to its closed position, thereby isolating the first wheel brake 302a, and possibly preventing loss of fluid from the hydraulic circuit 310. The brake system 300 even provides for isolation of a leaking first wheel brake 302a, for example, if the ECU 358 and/or the power transmission unit 320 are inoperable, by utilizing the intact power transmission unit 360 to provide pressure to the remaining three wheel brakes.

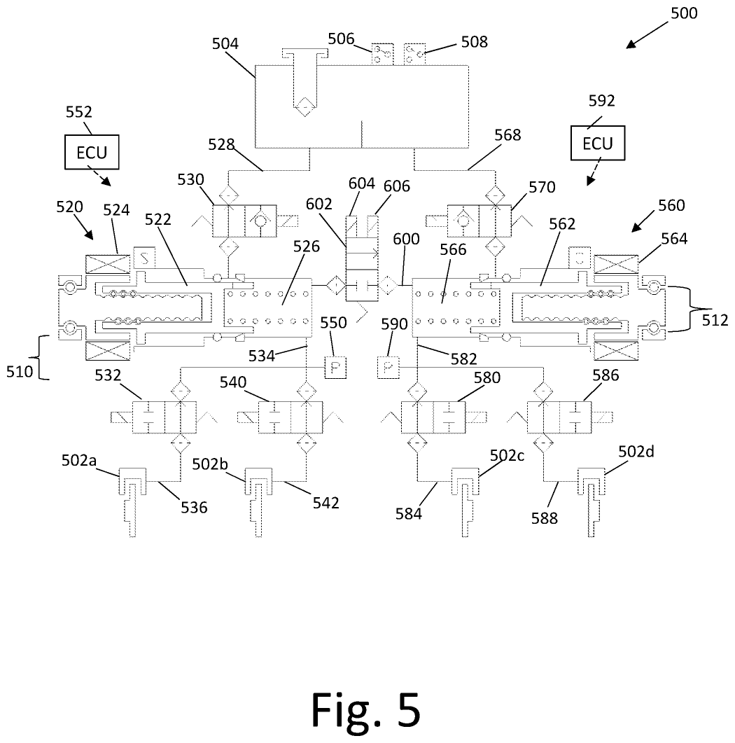

There is schematically illustrated in FIG. 5 a third embodiment of a vehicle brake system, indicated generally at 500. The brake system 500 is similar to the brake systems 10 and 300 described above. Many of the components of the brake system 500 function in a similar manner and may also be structurally similar as the corresponding components of the brake systems 10 and 300. Therefore, commonality in the components of the brake system 500 and 10, 300 may not necessarily be described in duplication below.

The brake system 500 includes wheel brakes 502a, 502b, 502c, and 502d. A reservoir 504 stores fluid for the brake system 500. The reservoir 504 may include first and second fluid reservoir sensors 506 and 508 to detect the fluid level of the reservoir 504. In a preferred embodiment of the invention, the brake system 500 includes first and second hydraulic circuits, indicated generally at 510 and 512, respectively. Unlike the brake system 10, the first and second hydraulic circuits 510 and 512 are not completely separate from one another.

The first hydraulic circuit 510 includes a power transmission unit, indicated generally 520, which is similar in function and structure as the power transmission units described above. The power transmission unit 520 includes a piston 522 moveable by a motor 524 for pressurizing a pressure chamber 526. The pressure chamber 526 of the power transmission unit 520 is selectively in communication with the reservoir 504 via a conduit 528. Unlike the brake systems 10 and 300, the brake system 500 has a solenoid actuated reservoir valve 530 for selectively cutting off the flow of fluid from the pressure chamber 526 to the reservoir 504.

The first hydraulic circuit 510 further includes a first valve 532 that is in fluid communication with the power transmission unit 520 via a conduit 534. The first valve 532 is in fluid communication with the wheel brake 502a via a conduit 536. The first hydraulic brake circuit 510 also includes a second valve 540 that is in fluid communication with the power transmission unit 520 via the conduit 534. The second valve 540 is in fluid communication with the wheel brake 502b via a conduit 542. The first and second valves 532 and 540 may be configured as solenoid actuated digital type on/off valves such that fluid communication is permitted or restricted therethrough. Alternatively, the first and second valves 532 and 540 may be configured to be operated in an electronically proportionally controlled manner and not merely a digital type on/off valve. Thus, the pressure and/or flow rate through the valves 532 and 540 may be controlled between their extreme open and closed positions.

The first hydraulic circuit 510 may further include a pressure sensor or pressure transducer 550 for detecting the pressure within the fluid conduit 534 and the pressure chamber 526 of the power transmission unit 520. The pressure transducer 550 is in communication with an electronic control unit or ECU 552. Similar to the ECUs described above, the ECU 552 may include a microprocessor for receiving signals from various vehicle sensors, as well as sensors from the brake system 500, to control the power transmission unit 520 to regulate the amount of hydraulic pressure within the fluid conduit 534.

The second hydraulic circuit 512 includes a power transmission unit, indicated generally 560, which is similar in function and structure as the power transmission units described above. The power transmission unit 560 includes a piston 562 moveable by a motor 564 for pressurizing a pressure chamber 566. The pressure chamber 566 of the power transmission unit 560 is selectively in communication with the reservoir 504 via a conduit 568. A reservoir valve 570 selectively shuts off the flow of fluid from the pressure chamber 566 to the reservoir 504.

The second hydraulic circuit 512 further includes a third valve 580 that is in fluid communication with the power transmission unit 520 via a conduit 582. The third valve 580 is in fluid communication with the wheel brake 502c via a conduit 584. The second hydraulic brake circuit 512 also includes a fourth valve 586 that is in fluid communication with the power transmission unit 560 via the conduit 582. The fourth valve 586 is in fluid communication with the wheel brake 502d via a conduit 542. The third and fourth valves 580 and 586 may be configured as solenoid actuated digital type on/off valves such that fluid communication is permitted or restricted therethrough. Alternatively, the first and second valves 580 and 586 may be configured to be operated in an electronically proportionally controlled manner and not merely a digital type on/off valve. Thus, the pressure and/or flow rate through the valves 580 and 586 may be controlled between their extreme open and closed positions.

The first hydraulic circuit 512 may further include a pressure sensor or transducer pressure 590 for detecting the pressure within the fluid conduit 582 and the pressure chamber 566 of the power transmission unit 560. The pressure transducer 590 is in communication with an electronic control unit or ECU 592. Similar to the ECUs described above, the ECU 592 may include a microprocessor for receiving signals from various vehicle sensors, as well as sensors from the brake system 500, to control the power transmission unit 560 to regulate the amount of hydraulic pressure within the fluid conduit 582.

Unlike the brake systems 10 and 300 described above, the power transmission units 520 and 560 of the brake system 500 are connected together such that the pressure chambers 526 and 566, respectively, are selectively in fluid communication with each other by a conduit 600. Located within the conduit 600 is a solenoid actuated normally closed connector valve 602. The connector valve 602 may be configured as solenoid actuated digital type on/off valves such that fluid communication is permitted or restricted therethrough. Alternatively, the connector valve 602 may be configured to be operated in an electronically proportionally controlled manner. Preferably, the connector valve 602 is controllable by both of the ECUs 552 and 592. In one embodiment, the connector valve 602 is a dual wound solenoid valve, represented schematically by solenoids 604 and 606.

In a preferred embodiment of the brake system 500, the reservoir valve 530 is connected to and actuated by the ECU 592 of the second hydraulic circuit 512. The reservoir valve 570 is connected to and actuated by the ECU 552 of the first hydraulic circuit 510. Note that the reservoir valves 530 and 570 need not be designed to be controllable in a multiplex manner. However, the connector valve 602 and the first, second, third, and fourth valves 532, 540, 580, and 586 are preferably designed to be controllable in a multiplex operation.

It is noted that the brake system 500 does not include a pedal simulator and, therefore, the brake system 500 may be designed for an autonomous drive vehicle wherein there is no driver to press on a brake pedal. Thus, the brake system 500 is solely controlled by the ECUs 552 and 592 without any driver input. It should be understood that the brake system 500 could be configured similar to the brake systems 10 and 300 such that the brake system 500 has a pedal simulator connected to the ECUs 552 and 592 in a conventional non-autonomous vehicle. It should also be noted that the brake systems 10 and 300 could be designed for an autonomous drive vehicle, thereby eliminating the pedal simulators 200 and 400.

During a normal brake apply event, the brake system 500 operates very similarly to the operation of the brake system 10. The ECUs 552 and 592 control the power transmission units 520 and 560, respectively, to provide pressurized fluid to the wheel brakes 502a, 502b, 502c, and 502d via the open first, second, third, and fourth valves 532, 540, 580, and 586. During a normal braking event, the connector valve 602 is in its normally closed position, thereby preventing fluid communication between the pressure chambers 526 and 566 of the power transmission units 520 and 560, respectively. Thus, pressure regulation between the first and second hydraulic circuits 510 and 512 are separate. Note that the reservoir valves 520 and 570 may remain in their normally open positions. It is also noted that during a normal brake apply, none of the solenoid actuated valves of the brake system 500 are energized. This is an advantage over the brake system 300, wherein actuation of four solenoid valves require actuation during a normal brake apply and are generally continuously energized during an ignition cycle.

Under certain failed conditions, the brake system 500 may be operated to provide pressurized fluid from one of the power transmission units to both of the hydraulic circuits. For example, if the power transmission unit 520 were to fail and/or the ECU 552 associated with the first hydraulic circuit 510 was inoperable, the ECU 592 could enter into a failure mode by energizing the connector valve 602 to its open position. The opening of the connector valve 602 permits pressurized fluid from the pressure chamber 566 of the power transmission unit 560 to into the pressure chamber 526 of the power transmission unit 520, thereby pressurizing the conduit 534. The normally open first and second valves 532 and 540 permit actuation of the wheel brakes 502a and 502b. Note that the ECU 592 will also energize the solenoid valve 530 under this failed brake condition to close off communication from the pressure chamber 526 of the power transmission unit 520 to the reservoir 504 in case the piston 522 is fully retracted. The power transmission unit 560 can then provide pressurized fluid for all four of the wheel brakes 502a, 502b, 502c, and 502d. Note that although the ECU 592 may be able to apply pressure to the first and second wheel brakes 502a and 502b, the brake system 500 may not be able to provide independent control of the first and second wheel brakes 502a and 502b due to lack of control of the first and second valves 532 and 540 if the brake failure was due to a failed ECU 552. In an alternate embodiment, however, the four valves 532, 540, 580, and 586 could be configured as multi-wound valves such that both of the ECUs 552 and 592 are connected to and are able to separately control all of the valves 532, 540, 580, and 586 such that the brake system 500 can provide independent control of all wheel brakes.

It is noted that there are some brake system failures in which the brake system 300 has an advantage over the brake system 500. For example, if a catastrophic failure or leakage occurred in the conduit 534 or the pressure transducer 550, the brake system 500 would need to operate the connector valve 602 in its closed position to prevent fluid leakage. However, if a leakage occurred at the pressure transducer 350 of the brake system 300, the power transmission unit 360 could still supply pressurized fluid to all of the wheel brakes since the normally closed first, second, third, and fourth valves 330, 334, 338, and 342 prevent leakage.

Instead of using a single connector valve 602 in which both of the ECUs 552 and 592 are connected thereto, the brake system 500 could be configured to use a pair of valves with single wound coils, wherein each one is connected to an ECU 552 and 592, wherein one valve is connected to ECU 552, and the other is connected to the ECU 592.

It is also noted that any of the brake systems described above could be configured such that the two ECUs communicate with each other and may pass information or control various components of the brake system.

With respect to the various valves of the brake system 10, the terms “operate” or “operating” (or “actuate”, “moving”, “positioning”) used herein (including the claims) may not necessarily refer to energizing the solenoid of the valve, but rather refers to placing or permitting the valve to be in a desired position or valve state. For example, a solenoid actuated normally open valve can be operated into an open position by simply permitting the valve to remain in its non-energized normally open state. Operating the normally open valve to a closed position may include energizing the solenoid to move internal structures of the valve to block or prevent the flow of fluid therethrough. Thus, the term “operating” should not be construed as meaning moving the valve to a different position nor should it mean to always energizing an associated solenoid of the valve.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A brake system for operating first, second, third, and fourth wheel brakes, the brake system comprising:
a first hydraulic brake circuit defining a first fluid conduit connected to the first and second wheel brakes, the first hydraulic brake circuit including:
a first source of pressurized fluid for providing pressurized fluid to the first conduit;
a first valve arrangement adapted to selectively provide pressurized fluid from the first conduit to the first and second wheel brakes; and
a first electronic control unit for controlling the first source of pressurized fluid and the first and second valves; and
a second hydraulic brake circuit defining a second fluid conduit connected to the third and fourth wheel brakes, the second hydraulic brake circuit including:
a second source of pressurized fluid for providing pressurized fluid to the second conduit;
a second valve arrangement adapted to selectively provide pressurized fluid from the second conduit to the third and fourth wheel brakes; and
a second electronic control unit separate from the first electronic control unit, wherein the second electronic control unit controls the second source of pressurized fluid and the third and fourth valves.

2. The brake system of claim 1 further including a fluid reservoir, and wherein the first and second hydraulic brake circuits are separate from one another such that the only fluid communication between the first and second hydraulic brake circuits is with the reservoir.

3. The brake system of claim 1, wherein the first source of fluid pressure is a first power transmission unit including a first motor driven piston for pressurizing a first pressure chamber within the first power transmission unit for providing pressurized fluid to the first fluid conduit, and wherein the second source of fluid pressure is a second power transmission unit including a second motor driven piston for pressurizing a second pressure chamber within the second power transmission unit for providing pressurized fluid to the second fluid conduit.

4. The brake system of claim 3, wherein the first valve arrangement includes:
a first valve adapted to selectively provide pressurized fluid from the first fluid conduit to the first wheel brake; and
a second valve adapted to selectively provide pressurized fluid from the first fluid conduit to the second wheel brake;
and wherein the second valve arrangement includes:
a third valve adapted to selectively provide pressurized fluid from the second fluid conduit to the third wheel brake; and
a fourth valve adapted to selectively provide pressurized fluid from the second fluid conduit to the fourth wheel brake.

5. The brake system of claim 4, wherein the first electronic control unit provides multiplex control of the first and second valves to control the pressures at each of the first and second wheel brakes independently from one another, and wherein the second electronic control unit provides multiplex control of the third and fourth valves to control the pressures at each of the third and fourth wheel brakes independently from one another.

6. The brake system of claim 4, wherein the first hydraulic brake circuit further includes:
a fifth valve adapted to selectively provide pressurized fluid from the first fluid conduit to the third wheel brake; and
a sixth valve adapted to selectively provide pressurized fluid from the first fluid conduit to the fourth wheel brake, and wherein the first electronic control unit controls the fifth and sixth valves.

7. The brake system of claim 6, wherein the second hydraulic brake circuit further includes:
a seventh valve adapted to selectively provide pressurized fluid from the second fluid conduit to the first wheel brake; and
a sixth valve adapted to selectively provide pressurized fluid from the second fluid conduit to the second wheel brake, and wherein the second electronic control unit controls the seventh and eighth valves.

8. The brake system of claim 7, wherein the first electronic control unit continuously operates the fifth and sixth valves in closed positions during normal braking to prevent the flow of fluid from the first power transmission unit to the third and fourth wheel brakes.

9. The brake system of claim 8, wherein the second electronic control unit continuously operates the seventh and eighth valves in closed positions during normal braking to prevent the flow of fluid from the second power transmission unit to the first and second wheel brakes.

10. The brake system of claim 4, wherein the brake system further includes a connector valve selectively permitting fluid communication between the first and second pressure chambers of the first and second power transmission units.

11. The brake system of claim 10, wherein the connector valve is controllable by both the first and second electronic control units.

12. The brake system of claim 11, wherein the connector valve includes a double wound solenoid.

13. The brake system of claim 10, wherein the brake system further includes:
a fluid reservoir;
a first reservoir valve for selectively permitting fluid communication between the reservoir and the first pressure chamber of the first power transmission unit; and
a second reservoir valve for selectively permitting fluid communication between the reservoir and the second pressure chamber of the second power transmission unit.

14. The brake system of claim 13, wherein the first reservoir valve is controllable by the second electronic control unit, and wherein the second reservoir valve is controllable by the first electronic control unit.

15. The brake system of claim 1 further including a pedal simulator having;
a housing having a bore;
a simulator piston moveably disposed in the housing; and
a spring arrangement biasing the piston.

16. The brake system of claim 13, wherein the pedal simulator further includes:
a first travel sensor capable of producing a signal that is indicative of the length of travel of the simulator piston, wherein the first travel sensor communicates with the first electronic control unit; and
a second travel sensor separate from the first travel sensor, wherein the second travel sensor is capable of producing a signal that is indicative of the length of travel of the simulator piston, and wherein the second travel sensor communicates with the second electronic control unit.

17. The brake system of claim 16, wherein the pedal simulator further includes third and fourth travel sensors capable of producing a signal that is indicative of the length of travel of the simulator piston, wherein the third travel sensor communicates with the first electronic control unit, and wherein the fourth travel sensor communicates with the second control unit.

18. The brake system of claim 15, wherein the simulator piston is slidably disposed in the bore defining a fluid chamber such that the position of the simulator piston within the bore defines a volume of the fluid chamber, and wherein the fluid chamber of the pedal simulator is in fluid communication with a fluid reservoir.

19. The brake system of claim 15, wherein the pedal simulator includes a member engaging the simulator piston to provide a progressive rate of friction between the simulator piston and the member as the simulator piston travels within the housing of the pedal simulator.

20. The brake system of claim 18, wherein the spring arrangement of the pedal simulator includes a plurality of spring elements having different spring rate characteristics.
